(19) United States
(12) Patent Application Publication
(10) Pub. No.: US 2020/0053467 A1
(43) Pub. Date: Feb. 13, 2020

(54) SPEAKER

(71) Applicant: SOUND FUN CORPORATION, Tokyo (JP)

(72) Inventors: Kazunori SATO, Tokyo (JP); Nobuhiro MIYAHARA, Tokyo (JP); Yoshio SAKAMOTO, Tokyo (JP)

(21) Appl. No.: 16/497,018

(22) PCT Filed: Mar. 22, 2018
(86) PCT No.: PCT/JP2018/011559

§ 371 Date: Sep. 24, 2019

(30) Foreign Application Priority Data
Mar. 26, 2017 (JP) 2017-060263

(51) Int. Cl. H04R 7/12; H04R 9/06; H04R 1/28

(52) U.S. Cl. CPC H04R 7/122; H04R 9/063; H04R 2209/041; H04R 2400/11; H04R 1/2873

(57) ABSTRACT

[Problem] To provide a speaker that is capable of emitting higher-volume and clearer sounds which hard-of-hearing individuals and hearing individuals can hear together without inconvenience by not suppressing vibration of the curved diaphragm and therefore efficiently transmitting kinetic energy converted from the electric energy of a sound signal to a curved diaphragm, and also has a reduced weight and size and is easy to manufacture. [Solution] A speaker 10 of the present invention includes: a diaphragm 1 curved in one direction; a driver unit 2 that vibrates the diaphragm in accordance with an inputted electric signal; and a frame body 3 supporting the diaphragm and the driver unit. One end side and another side of the diaphragm in the direction of curvature are attached to the frame body via edge parts 15 that do not interfere with the vibration. Also, the driver unit is in contact with one surface of the diaphragm and fixedly attached to the frame body.

### TECHNICAL FIELD

The present invention relates to a speaker sounds from which are barrier free for hard-of-hearing individuals and hearing individuals and can be heard by hard-of-hearing individuals or hearing individuals together. Specifically, the present invention relates to a technique that enables a speaker to emit sounds which hard-of-hearing individuals can hear together with hearing individuals without putting a hearing aid on, enables such a speaker to have a reduced weight and size, and enables such a speaker to be manufactured easily.

### BACKGROUND ART

Generally, many of speakers incorporated in audio equipment are dynamic speaker units. This type of speaker unit includes at least a donut-shaped magnet (permanent magnet), a voice coil inserted in a cylindrical space being the hole in this magnet, and a conically-shaped diaphragm (cone) attached to this voice coil. In such a speaker, as a sound signal flows through the voice coil, the voice coil vibrates in the front-rear direction in accordance with the waveform of the sound signal and the diaphragm, attached to the voice coil, vibrates together, thereby generating a compression wave (longitudinal wave) with a waveform equivalent to the sound signal and emitting a sound.

Also, planar speakers with a diaphragm of a flat plate shape (planar diaphragm) fixed to a rectangular frame such that the diaphragm can vibrate has been known as well. Such a planar speaker generates a compression wave with vibration of the planar diaphragm pushing air over a large area in parallel, and emits a sound.

Here, sounds from speakers using a cone and speakers using a planar diaphragm are difficult to hear satisfactorily for hard-of-hearing individuals without putting a hearing aid on.

In view of this, the applicant has proposed speakers that generate sounds audible to hard-of-hearing individuals, the speakers including a casing with a hollow structure, a drive unit housed in the casing, and a curved diaphragm disposed on the front surface of the case, and configured to emit a sound by transmitting vibration of the drive unit to an edge portion of the curved diaphragm (see Patent Documents 1 and 2, for example).

Such speakers using a curved diaphragm have been known to be capable of emitting sounds audible to, of course, hearing individuals and also to not all but some hard-of-hearing individuals without putting a hearing aid. Further, sounds from the speakers using a curved diaphragm according to the inventions described in Patent Documents 1 and 2 have been confirmed to be clearly audible from a distance in subsequent demonstration tests.

Here, in the speakers of Patent Documents 1 and 2, the curved diaphragm is disposed so as to cover an opening provided in the casing, and the drive unit is attached to contact the edge portion of the curved diaphragm. For this reason, the speakers are structurally large and have poor space factors, which leads to a problem of being unable to be installed or mounted depending on the application. It is difficult to sufficiently reduce the weight and size of the speakers, for example, for installation on a wall surface or a ceiling in a building, installation in an automobile, a train car, an aircraft, or the like, or mounting in an electronic device, a mobile terminal, or the like.

Meanwhile, a speaker has also been proposed in which a rectangular diaphragm is formed to be curved along its longitudinal direction and supported with its opposite end portions further pressed in the bending direction via pressing members, and a driver is attached to a substantially center portion of the diaphragm and driven to emit a sound (see Patent Document 3, for example).

A structure as described above in which a driver is attached to a substantially center portion of a curved diaphragm is assumed to be able to make a speaker more planar and lighter in weight than the speakers of Patent Documents 1 and 2.

Here, to emit a high-volume and clear sound from a speaker using a curved diaphragm, it is ideal to transmit the entire kinetic energy of its drive unit converted from electric energy to the curved diaphragm side.

However, in the speaker of Patent Document 3, the opposite end portions of the curved diaphragm are supported with a certain pressure constantly applied thereto via the pressing members, such as shock-absorbing members. For this reason, when kinetic energy converted from the electric energy of a sound signal is transmitted to the curved diaphragm side, it is highly likely that the pressing members suppress the vibration of the curved diaphragm, thereby lowering the efficiency of transmission of the kinetic energy from the driver. This leads to an assumption that the speaker cannot emit higher-volume and clearer sounds.

Moreover, the speaker of Patent Document 3 has a structure in which a magnetic circuit is attached to the curved diaphragm, in other words, a driver is hanging from the curved diaphragm. This leads to an assumption that the driver's recoil reduces (cancels out) the kinetic energy to be transmitted to the curved diaphragm side.

### PRIOR ART DOCUMENTS

### Patent Documents

Patent Document 1: Japanese Patent No. 5668233

Patent Document 2: Japanese Patent Application Publication No. 2016-140060

Patent Document 3: Japanese Patent No. 3905814

### SUMMARY OF INVENTION

### Technical Problem

The present invention has been made in view of the above circumstances, and an object thereof is to provide a speaker that is capable of emitting higher-volume and clearer sounds which hard-of-hearing individuals and hearing individuals can hear together without inconvenience by not suppressing vibration of the curved diaphragm and therefore efficiently transmitting kinetic energy converted from the electric energy of a sound signal to a curved diaphragm, and also has a reduced weight and size and is easy to manufacture.

### Solution Problem

A speaker according to the present invention is an audio device sounds from which can be heard by hard-of-hearing individuals and hearing individuals together. It includes: a diaphragm curved in one direction as extending from one end side to another end side; a driver unit that vibrates the diaphragm in accordance with an inputted electric signal; and a frame body holding the diaphragm and the driver unit. The one end side and the other end side of the diaphragm are attached to the frame body via edge parts having such hardness and shape as not to impair vibration, and the driver unit is in contact with one surface of the diaphragm and fixedly attached to the frame body.

Also, in the speaker according to the present invention, the driver unit is attachable to one of the surfaces of the diaphragm. Specifically, if making the speaker more planar does not have to be considered, the driver unit may be attached to either the concave surface side or the convex surface side of the diaphragm.

Also, in the speaker according to the present invention, in the case where the driver unit is attached to the concave surface side of the diaphragm, it is desirable that the driver unit be attached to be housed in a bow-shaped region defined by the diaphragm.

Also, in the speaker according to the present invention, any number of driver units can be attached to any positions on one surface of the diaphragm. Specifically, it is possible to, for example, attach only one driver unit to a center portion of the diaphragm, attach only one driver unit to any portion of the diaphragm other than a center portion, attach a plurality of driver units to portions of the diaphragm including a center portion, or attach a plurality of driver units to portions of the diaphragm excluding a center portion according to the shape and size of the diaphragm.

Also, in the speaker according to the present invention, the driver unit can be a moving coil actuator or a moving magnet actuator. However, considering the sound pressures in a high range, it is desirable that the speaker according to the present invention include a moving coil actuator.

Also, in the speaker according to the present invention, it is desirable that the frame body include a side surface having a width larger than or equal to the vibration stroke of the diaphragm.

Also, in the speaker according to the present invention, it is desirable that a side end portion of the diaphragm is bent toward the frame body side.

Further, in the speaker according to the present invention, it is desirable that the edge members be more flexible than the diaphragm. For example, the edge parts may be shaped from a material more flexible than the diaphragm, or shaped from the same material as the diaphragm to be thinner than the diaphragm.

### Advantageous Effects of Invention

In the speaker according to the present invention, a diaphragm curved in one direction has one end side and another end side in the direction of curvature attached to a frame body via edge parts that do not impair vibration. In this way, vibration of the diaphragm is not suppressed and therefore kinetic energy converted from the electric energy of a sound signal is efficiently transmitted to the diaphragm. Accordingly, the speaker is capable of emitting higher-volume and clearer sounds.

Also, the speaker according to the present invention, the driver unit is fixedly attached to the frame body. In this way, the drive unit is stably installed. This eliminates the possibility that the drive unit's recoil reduces (cancels out) the kinetic energy to be transmitted to the diaphragm side. Hence, the generated kinetic energy is sufficiently transmitted to the diaphragm side.

Further, in the speaker according to the present invention, the driver unit is attached to be in contact with one surface of the diaphragm. This reduces the thickness and size, so that the speaker is structurally small and also has an improved space factor. Moreover, the speaker is easy to manufacture.

Hence, it is possible to provide a smaller and lighter speaker capable of emitting higher-volume and clearer sounds which both hard-of-hearing individuals and hearing individuals can hear together without inconvenience clearly even from a distance by efficiently transmitting kinetic energy converted from the electric energy of a sound signal to a diaphragm.

### BRIEF DESCRIPTION OF DRAWINGS

FIG. 1 is a front perspective view illustrating a first speaker according to the present invention.

FIG. 2 is a front view illustrating the first speaker according to the present invention.

FIG. 3 is a left side view illustrating the first speaker according to the present invention.

FIG. 4 is a (front central horizontal) cross-sectional view along line A-A illustrated in FIG. 2.

FIG. 5 is an exploded view explaining the structure of the first speaker according to the present invention.

FIG. 6 is a partially enlarged front central horizontal cross-sectional view illustrating a method of attaching a voice coil (coil bobbin).

FIG. 7 is a partially enlarged front central horizontal cross-sectional view illustrating another method of attaching the voice coil (coil bobbin).

FIG. 8 is a partially enlarged front central horizontal cross-sectional view illustrating another method of attaching the voice coil (coil bobbin).

FIG. 9 is a partially enlarged front central horizontal cross-sectional view illustrating another method of attaching the voice coil (coil bobbin).

FIG. 10 is a partially enlarged front central horizontal cross-sectional view illustrating another method of attaching the voice coil (coil bobbin).

FIG. 11 is a partially enlarged front central horizontal cross-sectional view illustrating another method of attaching the voice coil (coil bobbin).

FIG. 12 is a back perspective view illustrating a second speaker according to the present invention.

FIG. 13 is a front central horizontal cross-sectional view of the second speaker according to the present invention.

FIG. 14 is a front perspective view illustrating a curved diaphragm used in the second speaker according to the present invention.

FIG. 15 is a bottom view illustrating the curved diaphragm used in the second speaker according to the present invention.

FIG. 16 is a front perspective view illustrating a third speaker according to the present invention.

FIG. 17 is a back perspective view illustrating a curved diaphragm and a frame body used in the third speaker according to the present invention.

FIG. 18 is a back view illustrating the third speaker according to the present invention.

FIG. 19 is a left side view illustrating the third speaker according to the present invention.

FIG. 20 is a front central horizontal cross-sectional view of the third speaker according to the present invention.

FIG. 21 is a front view illustrating a state where a plurality of speakers according to the present invention are combined.

FIG. 22 is a front view illustrating another state where a plurality of speakers according to the present invention are combined.

FIG. 23 is a front view illustrating another state where a plurality of speakers according to the present invention are combined.

### DESCRIPTION OF EMBODIMENTS

Next, exemplary embodiments of the present invention will be described.

It is to be noted that the embodiments to be discussed below are preferred specific examples of the present invention and therefore involve various technical limitations, but the scope of the present invention is not limited to these embodiments unless there is a statement of a particular limitation in the following description.

### First Embodiment

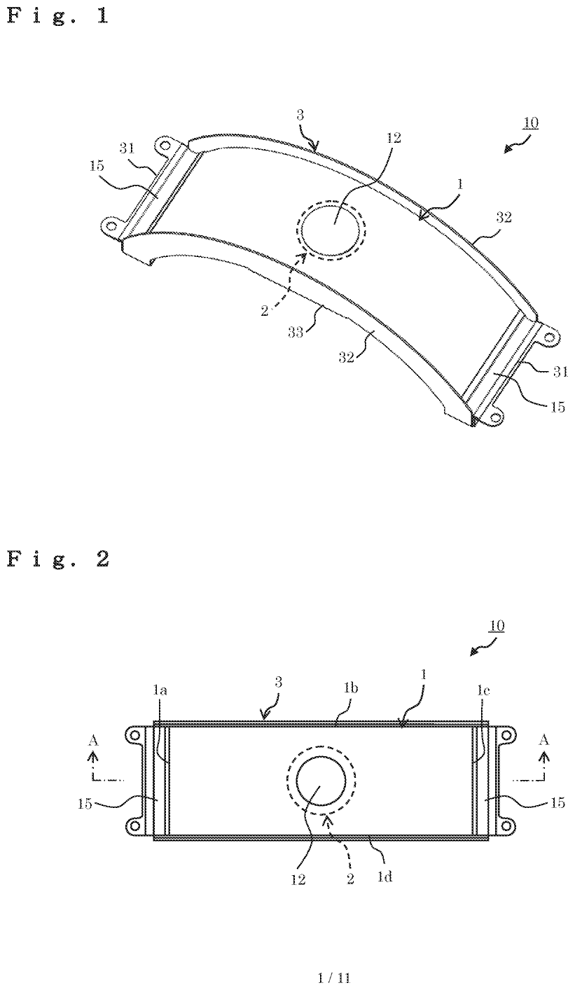

As illustrated in FIGS. 1 to 5, a speaker 10 of the present invention is an audio device sounds from which are barrier free for hard-of-hearing individuals and hearing individuals and can be heard by hard-of-hearing individuals and hearing individuals together (hereinafter referred to as “barrier-free speaker”), and is configured of at least a diaphragm 1, a driver unit 2, and a frame body 3 sounds from which can be heard by hard-of-hearing individuals and hearing individuals together.

The diaphragm 1 is a member that is flat and thin like a film or a sheet. It forms a curved surface portion curved in one direction as extending from one end 1a side from the other end 1c side on the opposite side, and is disposed such that the one end 1a side and the other end 1c side are held on a frame body 3 via edge parts 15.

This diaphragm 1 is desirably of a substantially rectangular shape in a plan view. However, the diaphragm 1 is not limited to this and may for example be of an elliptical shape, a polygonal shape, a gourd shape, or another shape in a plan view. Further, besides a member shaped to have a curved surface portion that is originally curved, the diaphragm 1 also refers to a member having flexibility and also resilience and being capable of forming a curved surface portion curved with these properties.

In the case where the diaphragm 1 is a member shaped to have a curved surface portion that is originally curved, the diaphragm 1 is attached to the frame body 3 with the convexly curved surface facing the front. In the case where the diaphragm 1 is a member having flexibility, the diaphragm 1 is attached to the driver unit 2 in the form of a flat plate in an upright position, deformed by being elastically bent from this state to form a curved surface, and attached to the frame body 3 with the deformed convexly curved surface side or concavely curved surface facing the front.

The material of this curved diaphragm (hereinafter referred to as “curved diaphragm”) 1 is preferably light in weight. However, if the material is too light in weight, the sound pressures of middle pitched sounds and high-pitched sounds may possibly be too high as compared to the sound pressures of low-pitched sounds. As the specific material of the curved diaphragm 1, a paper such as carbon paper, a synthetic resin having flexibility such as polyimide or polyester, a carbon fiber reinforced plastic (CFRP), a wood such as balsa wood, or a metal such as aluminum, beryllium, or boron can be used, for example. Meanwhile, the thickness of the curved diaphragm 1 is not particularly limited as long as the curved diaphragm 1 can be shaped to have a curved surface portion that is originally curved or deformed by being elastically bent.

Also, each edge part 15 is an easily deformable suspension that elastically fixes the curved diaphragm 1 to the frame body 3, and has an edge on one end side firmly attached to the curved diaphragm 1 and an edge on the other end side firmly attached to the frame body 3. Specifically, each edge part 15 has such hardness and shape as not to impair vibration of the curved diaphragm 1 and has a vibration suppression effect of suppressing divided vibration while a high range sound is outputted.

Thus, it is desirable that the one end 1a side and the other end 1c side of the curved diaphragm 1 be attached to the frame body 3 without being pressed but attached to the frame body 3 in a freely movable state via the edge parts 15 in, for example, a corrugation shape (wavy shape in cross section).

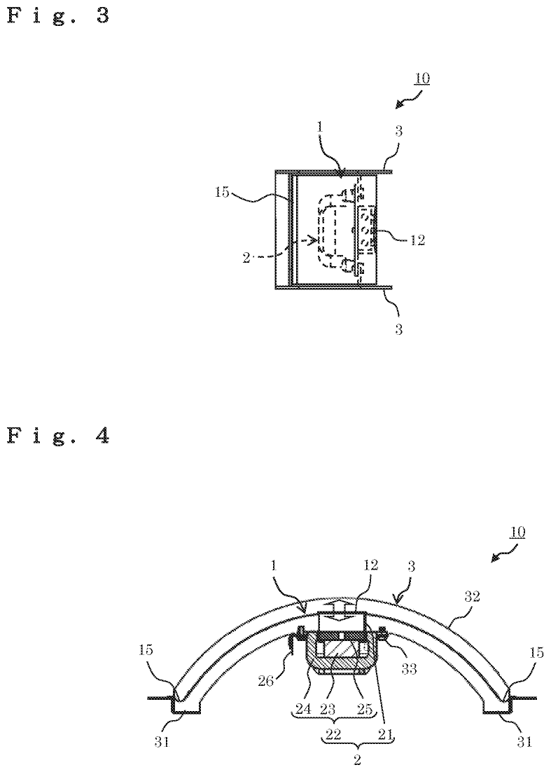

In FIG. 4, each edge part 15 is illustrated such that the center of its cross section is curved in an arc shape and the convexly curved portion faces the back surface side (the lower side in FIG. 4).

In order to avoid impairing vibration of the curved diaphragm 1 as mentioned above, the material of such edge parts 15 is desirably robust and more flexible than the curved diaphragm 1, such as rubber, urethane (synthetic resin), or fabric, and it is totally acceptable to use any material as long as it is in the form of a thin sheet suitable for the design purpose.

Specifically, a rubber edge is stretchable and also have good oscillation characteristics, so that the sound distortion is remarkably low and also the vibration suppression effect is significantly high. Moreover, with a rubber edge, it is easy to output low pitched sounds and, awing to its softness, soft sounds can be generated.

Being made of a foam material, a urethane edge is light in weight but has a certain vibration suppression effect and is easy to obtain balanced sounds.

Further, a fabric edge, as a material, has the highest durability, is light in weight, and is relatively inexpensive.

As described above, the curved diaphragm 1 is supported on the frame body 3 via the edge parts 15 so as to vibrate freely. This makes it difficult for the energy of vibration of the curved diaphragm 1 to be transmitted to the frame body 3, so that the loss of the energy is small.

In the present invention, the edge parts 15 may form a part of the curved diaphragm 1. Specifically, edge parts 15 separately formed in a thin form from the same material as the curved diaphragm 1 may be combined to the curved diaphragm 1. Alternatively, edge parts 15 thinner than the curved diaphragm 1 may be shaped integrally with the curved diaphragm 1.

Shaping the curved diaphragm 1 and the edge parts 15 from the same material makes it possible to obtain a barrier-free speaker at a lower material cost with less labor in the manufacturing process.

The driver unit 2 is an actuator that vibrates the curved diaphragm 1 in accordance with an inputted (conducted) electric signal (sound signal), and is attached to be in contact with one surface of the curved diaphragm 1. Specifically, the driver unit 2 is attached so as to apply its vibration to the curved surface of the curved diaphragm 1.

Meanwhile, the driver unit 2 is fixedly attached to the frame body 3. Specifically, the driver unit 2 receives reaction when driven. With the driver unit 2 in contact with and fixed to the frame body 3, drive of and reaction to the driver unit 2 vibrate the curved diaphragm 1. Thus, the sound pressure to be outputted to the outside can be raised.

Here, generating a high-volume sound requires a large diaphragm or high electric power but can also be achieved by applying a large force (vibration) to the curved diaphragm 1 from the driver unit 2. Such a driver unit 2 may be a moving coil actuator, for example.

Specifically, in this embodiment, sounds are reproduced with a moving coil actuator 2 in order to demonstrate a phenomenon of generating shear waves from the curved surface portion of the curved diaphragm 1. The moving coil actuator 2 is advantageous in design in that its stroke to drive the curved diaphragm 1 is large and a wide frequency band (sound range) is achieved.

Such a moving coil actuator 2 is formed of a voice coil 21 and a magnetic circuit 22, and the voice coil 21 is inserted and disposed in a magnetic gap formed by the magnetic circuit 22.

Then, by applying an electric signal or the like to this voice coil 21, the voice coil 21 vibrates in accordance with the applied signal, and the vibration is transmitted to the curved diaphragm 1, connected to the voice coil 21, thereby driving the curved diaphragm 1. Specifically, one end of the voice coil 21 is housed in the magnetic circuit (magnetic field) 22 while the other end is directly connected to the curved diaphragm 1. Hence, the inputted electric signal moves the voice coil 21, and that movement is transmitted to the curved diaphragm 1 and converted into an acoustic energy (sound).

Note that in the magnetic gap, a magnetic fluid is injected to hold the center of the voice coil 21 in the magnetic gap.

The voice coil 21 is formed by winding a coil wire of a desired diameter around an end portion of the outer periphery of a cylindrical coil bobbin to form a desired number of turns. This voice coil 21 can be connected and fixed by, for example, providing a flat portion 12 for attaching the voice coil which has a predetermined dimension larger than at least the outer periphery of the coil bobbin at a substantially center portion of the curved diaphragm 1, applying adhesive to the tip of the coil bobbin, and then disposing this tip on the concave surface side of the flat portion 12.

In this embodiment, the flat portion 12 of a predetermined dimension is provided at a substantially center portion of the curved diaphragm 1, and the voice coil 21 is attached to it to facilitate the attachment of the voice coil 21 to the curved diaphragm 1. However, the present invention is not limited to this. It is totally acceptable to attach the voice coil 21 directly to the concave surface side of the curved diaphragm 1. Of course, only a substantially center portion of the concave surface side of the curved diaphragm 1 may be formed flat and the voice coil 21 may be attached to it.

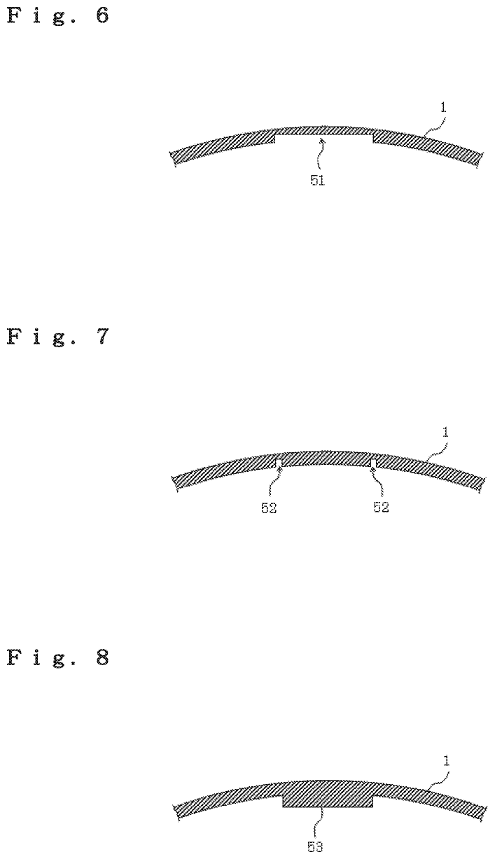

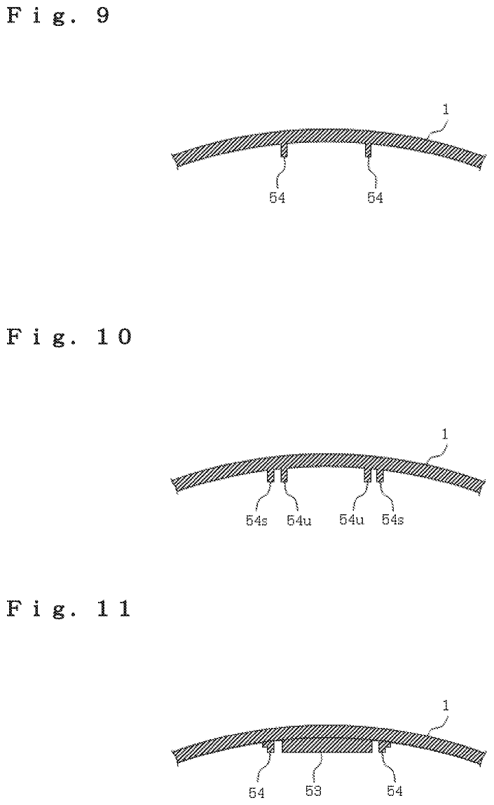

Also, in the present invention, as illustrated in FIGS. 6 to 11, a protruding portion or a recessed portion may be freely provided at the position on the curved diaphragm 1 to which to attach the voice coil 21, and the protruding portion or the recess portion may be used as a guide for positioning the voice coil 21. This makes it possible to obtain a degree of freedom in design. Specifically, for example, as illustrated in FIG. 6, a thin recessed step portion 51 having a predetermined dimension larger than at least the outer periphery of the coil bobbin may be provided at a substantially center portion of the curved diaphragm 1, and the voice coil 21 may be attached to it. As illustrated in FIG. 7, a recessed groove portion 52 having substantially the same shape and size as the coil bobbin may be provided at a substantially center portion of the curved diaphragm 1, and the voice coil 21 may be attached to it. As illustrated in FIG. 8, a thick protruding step portion 53 having such a shape and size as to be housed inside the voice coil and contacts the inner peripheral surface of the coil bobbin may be provided at a substantially center portion of the curved diaphragm 1, and the voice coil 21 may be attached to it. As illustrated in FIG. 9, a protruding rib portion 54 having such a shape and size as to be housed inside the voice coil and contact the inner peripheral surface of the coil bobbin or disposed outside the voice coil and contact the outer peripheral surface of the coil bobbin may be provided at a substantially center portion of the curved diaphragm 1, and the voice coil 21 may be attached to it.

Also, a thick protruding step portion or a protruding rib portion designed to be disposed inside the coil bobbin may be combined with a protruding rib designed to be disposed outside the coil bobbin. Specifically, a thick protruding step portion as illustrated in FIG. 8, which is disposed to contact the inner peripheral surface of the coil bobbin, and a protruding rib portion as illustrated in FIG. 9, which is disposed to contact the outer peripheral surface of the coil bobbin, may be provided, and the voice coil 21 may be attached to them. Alternatively, as illustrated in FIG. 10, a protruding rib portion 54u disposed to contact the inner peripheral surface of the coil bobbin and a protruding rib portion 54s disposed to contact the outer peripheral surface of the coil bobbin may be used together such that the tip of the coil bobbin is inserted and held between them.

The shape of the whole thick protruding step portion 53 and protruding rib portion 54 is not particularly limited. The shape may be any shape such as a circular shape, a polygonal shape such as a triangular shape or a rectangular shape, a star shape, or a heart shape in a plan view. Meanwhile, in the case of a protruding rib portion, it may be a wall body of a line shape, radial wall bodies spreading toward the periphery from a single point (or, conversely, converging toward the center from the periphery), or a frame-shaped body. Further, though not illustrated, these thick protruding step portion and protruding rib portion may be formed of a plurality of protruding pin bodies.

The thick protruding step portion 53, the protruding rib portion 54, and the protruding pin bodies increase the weight of the curved diaphragm 1. However, as a trade-off, they have the advantages of functioning as a guide for attachment of the voice coil 21 to the curved diaphragm 1 and of reinforcing the curved diaphragm 1 to prevent its breakage, deformation, and the like.

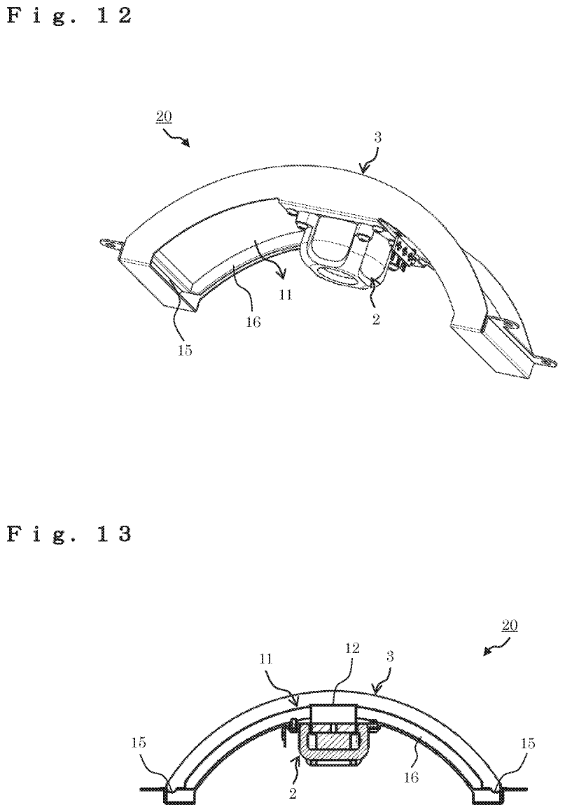

Note that the thick protruding step portion 53, the protruding rib portion 54, and the protruding pin bodies may be shaped integrally with the curved diaphragm 1, or separately shaped and attached to the curved diaphragm 1, as illustrated in FIG. 11. Also, the attachment of the voice coil 21 to the curved diaphragm 1 using a protruding portion (s) or a recessed portion is not limited to this embodiment, but is similarly applicable to the other embodiments to be described later.

Further, in the present invention, a neck portion being a hole of a predetermined dimension can be provided in a substantially center portion of the curved diaphragm 1, and the voice coil 21 can be connected and fixed by inserting the tip of the coil bobbin in the neck portion with adhesive applied to its outer periphery.

Note that in the case of the structure in which the voice coil 21 is attached to the neck portion, the top side of the voice coil 21 is open and exposed and is therefore closed with a lid body.

The magnetic circuit 22 is an internal magnet-type magnetic circuit having a shape adapted to drive the voice coil 21 and formed of a permanent magnet 23 of a circular column shape, a pod-shaped yoke (hereinafter referred to as “pod yoke”) 24 housing the permanent magnet 23 therein and made of a steel material, which is a good magnetic material, a disc-shaped plate 25 disposed over the permanent magnet 23 so as to close the pod yoke 24 and made of, likewise, a steel material, and so on. A neodymium magnet, an alnico magnet, or a ferrite magnet can be used as the permanent magnet 23. It is desirable to use a neodymium magnet, an alnico magnet, or the like for its ability to generate a stronger magnetic field than a ferrite magnet.

Note that it is totally acceptable to use a moving magnet actuator having an external magnet-type magnetic circuit using a ring-shaped ferrite magnet or the like as the driver unit 2.

The plate 25 is disposed on and attached to the upper surface of the cylindrical neodymium magnet 23, and the magnetic gap is formed by an inner peripheral portion of the pod yoke 24 obtained by cutting the inner periphery of the pod yoke 24 from its upper end to the lower surface of the neodymium magnet 23 to a predetermined diameter. Specifically, the plate 25 is attached with its outer periphery centered on the inner periphery of the pod yoke 24. Hence, a ring-shaped clearance, i.e., a ring-shaped gap, having a predetermined width is formed between the inner peripheral surface of the pod yoke 24 and the outer peripheral surface of the plate 25.

Also, the dimension of the magnetic gap in the depth direction is determined by the thickness of the plate 25 and the thickness (depth) of the inner periphery of the pod yoke 24. Hence, the magnetic force of the neodymium magnet 23 is guided to and converged at the gap by the pod yoke 24 and the plate 25, so that a magnetic flux appears at the gap, thereby forming a magnetic gap.

In this embodiment, a suspension member is not used which is called a damper disposed on an outer periphery portion of a voice coil bobbin in typical speaker units in the market. In other words, the speaker unit in this embodiment employs what is called a damper-less structure, in which the edge parts 15, disposed on the one end 1a side and the other end 1c side of the curved diaphragm 1, are used as suspension members to support the curved diaphragm 1 and the voice coil 21. Nonetheless, the present invention is not limited to this. It is totally acceptable to provide a conventional typical damper on the magnetic circuit 22 side, the frame body 3 side, or the like depending on the purpose.

Meanwhile, reference numeral 26 shown in FIG. 4 denotes an input terminal plug.

Here, the electric signal inputted into the driver unit 2 may a sound signal outputted from, for example, a television set, a radio, an audio player, a personal computer, a smart device, such as a smartphone or a tablet, or the like.

In FIGS. 1 to 5, the driver unit 2 is illustrated as a single unit attached to a center portion of the concave surface side of the curved diaphragm 1.

This reduces the thickness and size, so that the barrier-free speaker 10 is structurally small and also has an improved space factor. Moreover, since the driver unit 2 efficiently drives a center portion of the curved diaphragm 1, the barrier-free speaker 10 is capable of emitting higher-volume and clearer sounds.

Also, in FIGS. 1 to 5, the driver unit 2 is illustrated attached to be housed in the bow-shaped region defined by the curved diaphragm 1. Specifically, assuming the curved surface of the curved diaphragm 1 as an arc and a straight line connecting the one end 1a side and the other end 1c side of the curved diaphragm 1 in the shortest distance as a string, the driver unit 2 is desirably attached to be housed in the region surrounded by this arc and string.

In this way, the driver unit 2 does not project from the back surface (concave surface) side of the curved diaphragm 1. This further reduces the thickness and size, so that the barrier-free speaker 10 is structurally smaller and also has an improved space factor.

The frame body 3 holds the curved diaphragm 1 and the driver unit 2 and, as illustrated in FIGS. 1 and 4, includes a pair of straight diaphragm attachment portions 31 and 31, a pair of coupling portions 32, 32 curved in an arc shape, and a drive unit attachment portion 33. This drive unit attachment portion 33 is provided on the concave side of the coupling portions 32.

Also, the frame body 3 defines the outline of the periphery of the curved diaphragm 1 with the pair of diaphragm attachment portions 31 and 31 and the pair of coupling portions 32 and 32.

The pair of diaphragm attachment portions 31 and 31 are provided facing each other so as to support the one end 1a side and the other end 1c side of the curved diaphragm 1, respectively, as mentioned above.

The pair of coupling portions 32 and 32 are provided facing each other so as to hold the pair of diaphragm attachment portions 31 and 31 and the drive unit attachment portion 33 together.

The drive unit attachment portion 33 is provided at a position between the pair of diaphragm attachment portions 31 and 31, held together by the coupling portions 32, to enable the drive unit 2 to be attached to one surface of the curved diaphragm 1.

Here, the curved diaphragm 1 is attached such that its side end portions 1b and 1d extending along the direction of curvature are not in contact with the frame body 3 but clearances are left between the side end portions 1b and 1d and the inner surfaces of the pair of coupling portions 32 and 32 of the frame body 3. Specifically, the curved diaphragm 1 is attached with only the one end 1a side and the other end 1c side held on the frame body 3 via the edge parts 15.

By including these clearances, it is possible to permit the fine oscillating movement (vibration) of the curved diaphragm 1 while preventing sound waves generated on the back surface side as a result of driving the curved diaphragm 1 from traveling around to the front surface side of the curved diaphragm 1 and interfering sound waves generated on the front side.

Also, the frame body 3 may include side surfaces having a width larger than or equal to the vibration stroke of the curved diaphragm 1. Specifically, it is desirable that the pair of coupling portions 32 and 32 are wide along the direction of vibration of the curved diaphragm 1. In this embodiment, it is desirable that the coupling portions 32 have a dimension of at least 15 mm or larger on the assumption that the curved diaphragm 1 makes a vibration of 7.5 mm in each direction (15 mm in a reciprocating motion), for example. However, the design is not limited to this but can be changed as appropriate according to the vibration stroke of the curved diaphragm 1.

FIG. 4 illustrates the direction of vibration of the curved diaphragm 1 and the amount of movement (stroke) with the outlined arrow, and illustrates that the pair of coupling portions 32 and 32 have a width larger than or equal to this vibration stroke of the curved diaphragm 1.

By including such side surfaces, sound waves emitted from the front surface of the curved diaphragm 1 and sound waves emitted from the back surface are blocked by the side surfaces. This further reduces interference and attenuation of sound waves on the front and back surface sides. Accordingly, stable sound pressures and wider frequency band characteristics are obtained.

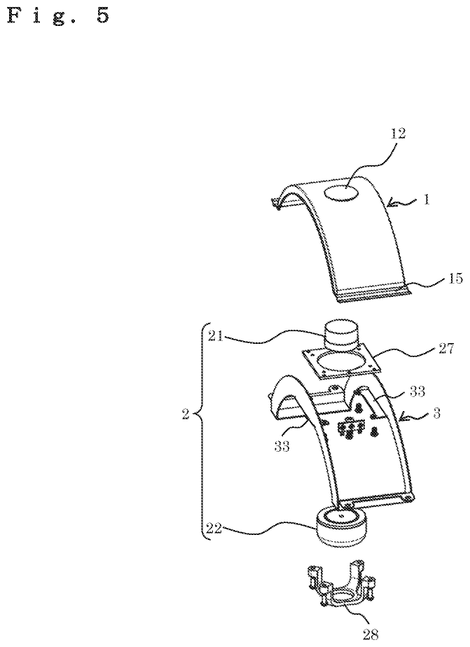

Moreover, as illustrated in FIG. 5, the drive unit 2 is attached and fixed to the drive unit attachment portion 33 of the frame body 3 with a frame body attachment plate 27 and a magnetic circuit holder 28. As a result, the outer periphery of the coil bobbin of the voice coil 21 of the drive unit 2 is connected and fixed to the flat portion 12, which is provided on the curved diaphragm 1.

Meanwhile, though not illustrated, in the barrier-free speaker of the present invention, a plurality of driver units 2 may be attached to one surface of the curved diaphragm 1.

Such a barrier-free speaker drives the one surface of the same curved diaphragm 1 with the plurality of driver units 2 . . . 2. Thus, by generating sound energy above the upper limit of a single driver unit 2 with the plurality of driver units 2 . . . 2, it is possible to generate larger shear waves and compression waves from the curved diaphragm 1. In this way, the barrier-free speaker is expected to emit high-volume and clear sounds.

### Second Embodiment

Meanwhile, as illustrated in FIGS. 12 to 15, a barrier-free speaker 20 of the present invention may use a curved diaphragm 11 with bent edges. Specifically, this embodiment differs from the above first embodiment in the structure of the curved diaphragm.

Note that in the embodiments to be discussed below, a description will be given mainly of parts different from the barrier-free speaker 10 according to the above first embodiment. Thus, similar constituent parts are denoted by the same reference numeral and will not be described, and the similar constituent parts are assumed to be the same unless otherwise described.

The curved diaphragm 11 is shaped as a single integral body having a curved surface portion that is originally curved, and also having a bent side end portion 16 with bent one end 11a, other end 11c, and side end portions 11b and 11d.

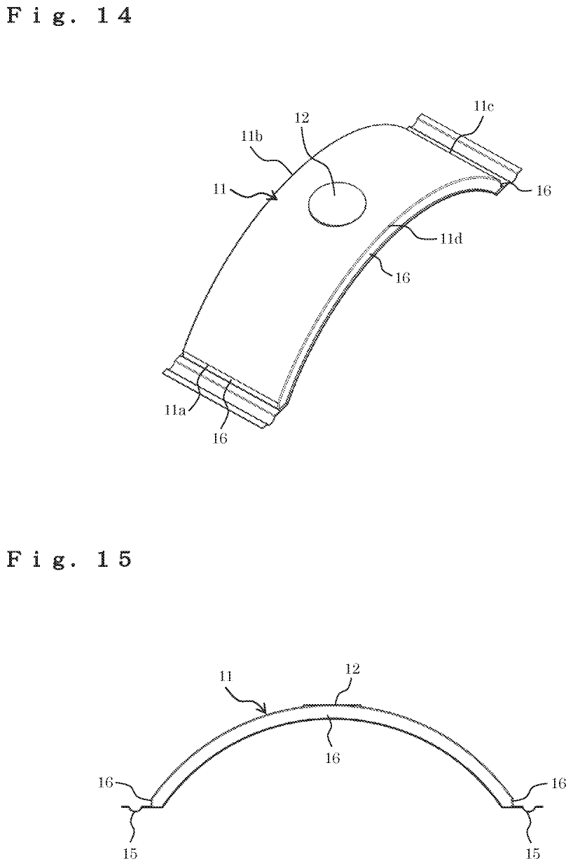

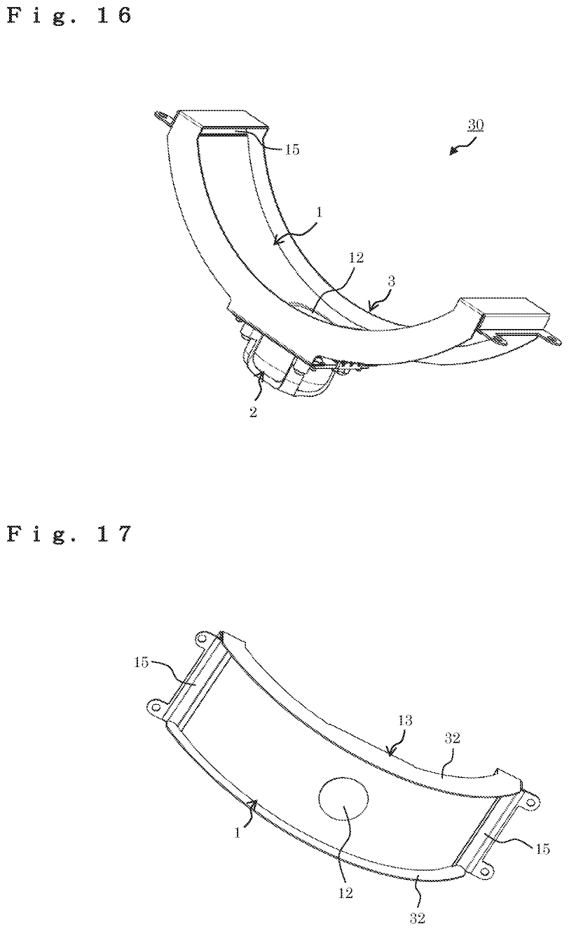

FIGS. 12 and 13 illustrate the barrier-free speaker 20 with the curved diaphragm 11 attached to the frame body 3 with the convexly curved surface facing the front. Also, FIGS. 14 and 15 illustrate the curved diaphragm 11 having the bent side end portion 16 with the side end portions 1b and 1d bent toward the concavely curved surface side of the curved surface portion.

As described above, by providing the bent side end portion 16 via bending the one end 11a, the other end 11c, and the side end portions 11b and 11d of the curved diaphragm 11, the strength of the curved diaphragm is significantly increased and also the ability to maintain its shape is improved. Moreover, sounds are prevented from traveling around to the opposite surface of the curved diaphragm 11, and therefore the sound quality is improved.

### Third Embodiment

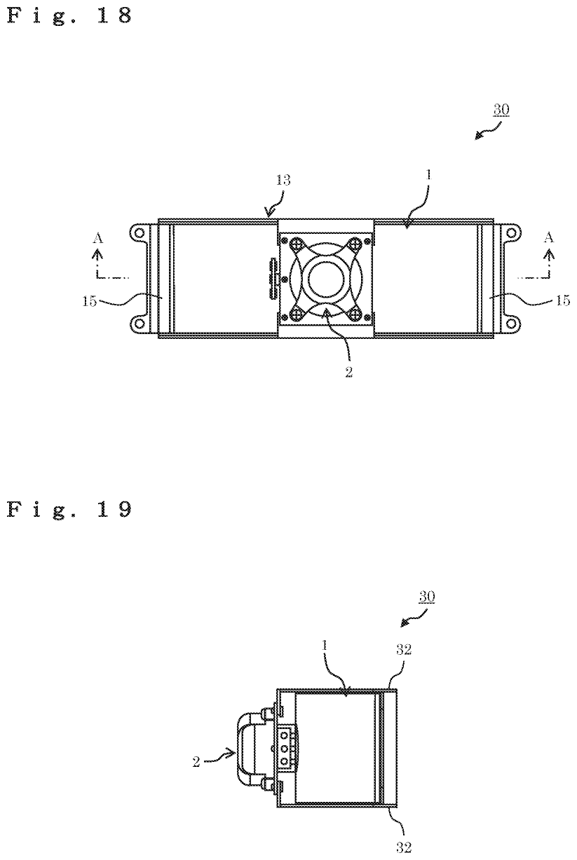

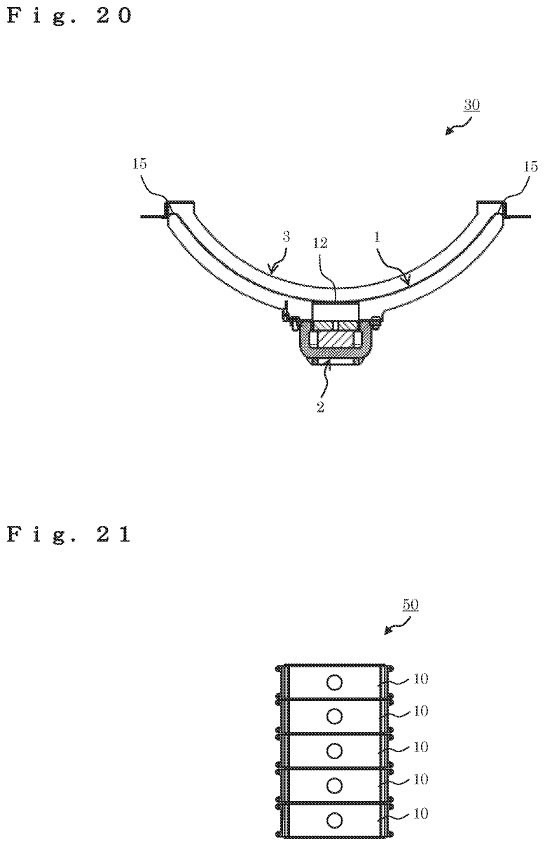

Meanwhile, as illustrated in FIGS. 16 to 20, a barrier-free speaker 30 of the present invention may be such that the driver unit 2 is attached the convex surface side of the curved diaphragm 1. Specifically, this embodiment differs from the above first embodiment in the orientation of the curved diaphragm and the structure of the frame body.

The curved diaphragm 1 has the same structure as that in the first embodiment but differs in the direction in which the curved diaphragm 1 is attached to a frame body 13 and also differs in the direction in which the side end portions 1b and 1d of the curved diaphragm 1 are bent. Specifically, the curved diaphragm 1 has a bent side end portion 16 obtained by bending the side end portions 1b and 1d toward the convexly curved surface side of the curved surface portion, and also is attached to the frame body 13 with the concavely curved surface facing the front.

The frame body 13 has the same basic structure as that of the frame body 3 in the first embodiment but differs in that the drive unit attachment portion 33 is provided on the convex side of the coupling portions 32. Hence, the driver unit 2 is attached to the convex surface side of the curved diaphragm 1.

With the driver unit 2 attached to the convex surface side of the curved diaphragm 1 and the curved diaphragm 1 placed with its concave surface side facing the front as described above, the barrier-free speaker 30 has the effect of emitting higher-volume and clearer sounds since the vibration of the curved diaphragm 1 is not suppressed and therefore kinetic energy converted from the electric energy of a sound signal is efficiently transmitted to the curved diaphragm 1, like the barrier-free speaker 10 discussed in the first embodiment. In addition, the barrier-free speaker 30 is very useful in a situation where it is unacceptable for the curved diaphragm 1 to project from a mounting surface such as a ceiling or a wall surface.

### Fourth Embodiment

Meanwhile, since each of the barrier-free speakers of the present invention has a reduced size and weight, a plurality of such barrier-free speakers may be combined and used. Specifically, a plurality of barrier-free speakers can be joined in a vertical line or a horizontal line, joined back to back, or joined in a ring shape.

Combining a plurality of barrier-free speakers in this manner vertically or horizontally spreads the direction in which sounds are emitted, increases the sound pressure, or generates omnidirectional sounds emitted in all directions.

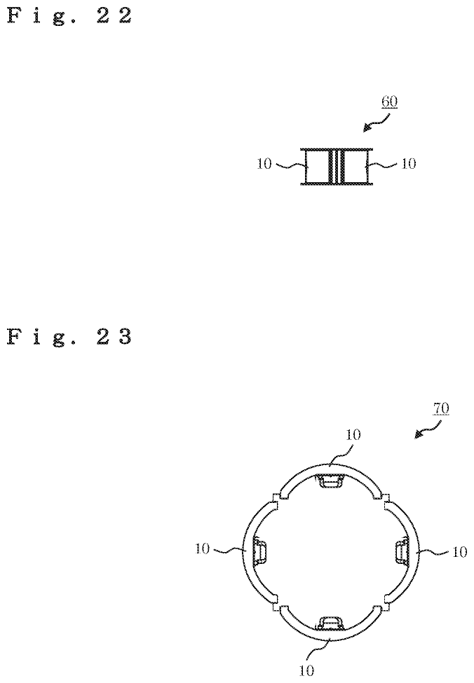

FIG. 21 illustrates a composite barrier-free speaker 50 with five barrier-free speakers 10 of the present invention stacked vertically and joined to each other. FIG. 22 illustrates a composite barrier-free speaker 60 with two barrier-free speakers 10 of the present invention joined to each other back to back. FIG. 23 illustrates a composite barrier-free speaker 70 with four barrier-free speakers 10 of the present invention joined to each other in a ring shape.

Note that the composite barrier-free speakers illustrated in FIGS. 21 to 23 are mere examples, and the number of barrier-free speakers combined and their arrangement can be determined as appropriate.

Also, the barrier-free speaker 10 in the above first embodiment is used in the composite barrier-free speakers illustrated in FIGS. 21 to 23. However, the barrier-free speaker is not limited to this. A composite barrier-free speaker can also use the barrier-free speaker 20 in the above second embodiment or use the barrier-free speaker 30 in the above third embodiment.

### REFERENCE SIGNS LIST

1, 11 curved diaphragm
1a one end
1b, 1d side end
1c other end
2 driver unit
3, 13 frame body
10, 20, 30 barrier-free speaker
12 flat portion
15 edge part
16 bent side end portion
21 voice coil
22 magnetic circuit
23 magnet
24 yoke
25 plate
26 input terminal plug
27 frame body attachment plate
28 magnetic circuit holder
31 diaphragm attachment portion
32 coupling portion
33 drive unit attachment portion
51 thin recessed step portion
52 recessed groove portion
53 thick protruding step portion
54 protruding rib portion

1. A speaker comprising at least:
a diaphragm curved in one direction as extending from one end side to another end side;
a driver unit that vibrates the diaphragm in accordance with an inputted electric signal; and
a frame body holding the diaphragm and the driver unit,
wherein
(i) only the one end side and the other end side of the diaphragm are attached to the frame body via edge parts having such hardness and shape as not to impair vibration, or
(ii) only the one end side and the other end side of the diaphragm are attached to the frame body via edge parts that elastically fix the one end side and the other end side, or
(iii) the one end side and the other end side of the diaphragm are attached to the frame body via edge parts having such hardness and shape, as not to impair vibration, and a side end of the diaphragm extending along a direction of curvature has a clearance between the side end and the frame body, or
(iv) the one end side and the other end side of the diaphragm are attached to the frame body via edge parts that elastically fix the one end side and the other end side, and a side end of the diaphragm extending along a direction of curvature has a clearance between the side end and the frame body, and
the driver unit is in contact with one surface of the diaphragm and fixedly attached to the frame body.

24. (canceled)

5. The speaker according to claim 1, wherein the driver unit is attached to a concave surface side of the diaphragm.

6. The speaker according to claim 5, wherein the driver unit is attached to be housed in a bow-shaped region defined by the diaphragm.

7. The speaker according to claim 1, wherein the driver unit is attached to a convex surface side of the diaphragm.

8. The speaker according to claim 1, wherein the driver unit is attached to a center portion of the diaphragm.

9. The speaker according to claim 1, wherein a plurality of the driver units are attached.

10. The speaker according to claim 1, wherein the driver unit includes a moving coil actuator.

11. The speaker according to claim 1, wherein the frame body includes a side surface having a width larger than or equal to a vibration stroke of the diaphragm.

12. The speaker according to claim 1, wherein a side end portion of the diaphragm is bent.

13. The speaker according to claim 1, wherein the edge parts are more flexible than the diaphragm.

14. The speaker according to claim 1, wherein the diaphragm has a rectangular shape.

15. The speaker according to claim 1, wherein the diaphragm has an elliptical shape, a polygonal shape, or a gourd shape.

16. The speaker according to claim 1, wherein a voice coil of the driver unit is connected and fixed to a flat portion provided on the diaphragm.

17. The speaker according to claim 1, wherein a voice coil of the driver unit is attached by using a protruding portion and/or a recessed portion provided on the diaphragm.

18. The speaker according to claim 1, wherein a voice coil of the driver unit is connected and fixed by using a neck portion being a hole provided in the diaphragm.

19. A composite speaker comprising a plurality of the speakers according to claim 1 combined in a vertical line.

20. A composite speaker comprising a plurality of the speakers according to claim 1 combined in a horizontal line.

21. A composite speaker comprising a plurality of the speakers according to claim 1 combined back to back.

22. A composite speaker comprising a plurality of the speakers according to claim 1 combined in a ring shape.
